(19) United States
(12) Patent Application Publication
(10) Pub. No.: US 2020/0213719 A1
(43) Pub. Date: Jul. 2, 2020

(54) SOUND GENERATING DEVICE

(71) Applicant: AAC Technologies Pte. Ltd., Singapore City (SG)

(72) Inventors: Bo Xiao, Shenzhen (CN); Ronglin Linghu, Shenzhen (CN); Xiaodong Liu, Shenzhen (CN)

(21) Appl. No.: 16/702,553

(22) Filed: Dec. 4, 2019

(30) Foreign Application Priority Data
Dec. 28, 2018 (CN) 201822240249.6

(51) Int. Cl. H04R 1/28; H04R 17/00

(52) U.S. Cl. CPC H04R 1/2834; H04R 17/00

(57) ABSTRACT

The present invention provides a sound generating device, including a housing and a vibration system accommodated in the housing, the vibration system including a diaphragm and a driving unit for driving the diaphragm to vibrate and generate sound. The driving unit includes a piezoelectric driving unit and a moving iron driving unit coupled in parallel with the piezoelectric driving unit, the piezoelectric driving unit including a piezoelectric sheet, the moving iron driving unit including a coil and a magnetic steel. The piezoelectric driving unit and the moving iron driving unit jointly drive the diaphragm to vibrate and sound.

### TECHNICAL FIELD

The present disclosure relates to the field of vibrating acoustic technology, in particular to a sound generating device.

### BACKGROUND

Traditionally, a sound generating device includes a housing and a vibration system accommodated in the housing. The vibration system generally includes a diaphragm and a single drive structure for driving the diaphragm to vibrate and generate sound.

Obviously, the sound generating device with the single drive structure has small driving force for driving the diaphragm to vibrate and generate sound, low vibration amplitude and poor product sensitivity, causing occurrence of defects such as a product distortion and the like.

### BRIEF DESCRIPTION OF THE DRAWINGS

FIG. 1 is a perspective structural view of a sound generating device in the present disclosure;

FIG. 2 is a sectional view along the AA direction of FIG. 1;

FIG. 3 is an exploded perspective view of a sound generating device in the present disclosure;

FIG. 4 is a schematic local view of a sound generating device in the present disclosure;

### DETAILED DESCRIPTION

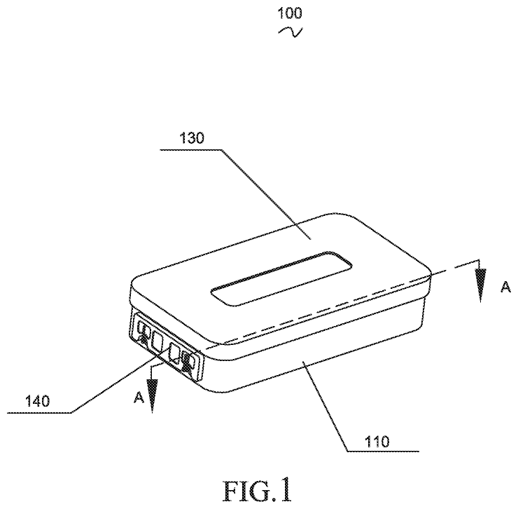

The present disclosure is described in detail below with reference to FIGS. 1 to 4.

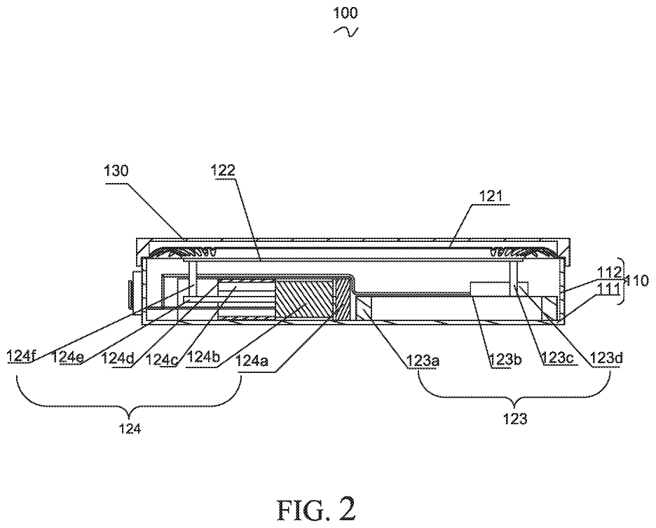

An embodiment of the present disclosure relates to a sound generating device. As shown in FIG. 1 and FIG. 2, the sound generating device 100 includes a housing 110, a vibration system accommodated in the housing 110, a cover plate 130 covering on the housing 110, and a circuit board 140. Here, the vibration system 120 includes a diaphragm 120, and a driving unit for driving the diaphragm 120 to vibrate and generate sound. The diaphragm 120 includes a dome 122 and a suspension 121 formed by bending and extending outward from the dome 122. The driving unit includes a piezoelectric driving unit 123 and a moving iron driving unit 124 coupled in parallel with the piezoelectric driving unit 123. The piezoelectric driving unit 123 includes a piezoelectric sheet 123b, and the moving iron driving unit 124 includes a coil 124b and a magnetic steel 124d. The piezoelectric driving unit 123 and the moving iron driving unit 124 jointly drive the diaphragm 121 to vibrate and generate sound.

In a sound generating device 100 with a structure of this embodiment, a driving unit of a vibration system 120 includes a piezoelectric driving unit 123 and a moving iron driving unit 124 coupled in parallel with the piezoelectric driving unit 123. The piezoelectric driving unit 123 includes a piezoelectric sheet 123b, and the moving iron driving unit 124 includes a coil 124b and a magnetic steel 124d. The piezoelectric driving unit 123 and the moving iron driving unit 124 jointly drive the diaphragm 121 to vibrate and generate sound. In this way, compared with a traditional sound generating device with a single drive structure, the sound generating device 100 of this embodiment may effectively increase driving force, increase vibration amplitude, enhance product sensitivity, broaden corresponding range, and at the same time, the sound generating device 100 with a dual drive structure may also effectively increase driving fulcrum, improve vibration balance, and improve product distortion.

Specifically, as shown in FIGS. 2, 3 and 4, the piezoelectric driving unit 123 includes a first base 123a fixed to the housing 110 and fixed to both ends of the piezoelectric sheet 123b, a first support 123c extending from the piezoelectric sheet 123b toward the diaphragm 121 and connected to the diaphragm 121, and a bump 123d fixing the piezoelectric sheet 123b to the first base 123a. In this way, piezoelectric effect of the piezoelectric sheet 123b may cause the piezoelectric sheet 123b to distort and deform, thereby driving first support 123c located on the piezoelectric sheet 123b to drive the diaphragm 121 to vibrate and generate sound.

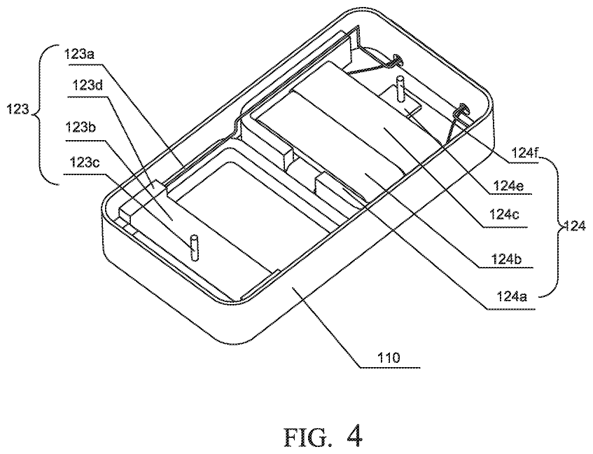

As shown in FIGS. 2 and 4, the first support 123c may be of a columnar structure. Of course, in addition to this, the first support 123c may be of other structures, and may be determined in accordance with actual needs. In order to simplify the structure of the piezoelectric driving unit 123, the first support 123c may be integrally formed with the piezoelectric sheet 123b.

As shown in FIGS. 2, 3 and 4, the moving iron driving unit 124 includes a second base 124a fixed to the housing 110 and accommodating the coil 124b, a pole core 124c fixed to the housing 110 and in an annular shape. The magnetic steel 124d is attached to both sides of the pole core 124c, and the magnetic steel 124d extends along a direction that is perpendicular to the vibration direction of the diaphragm 121. The moving iron driving unit 124 further includes a tongue-like plate 124e extending from the second base 124a through the coil 124b and the pole core 124c, and a second support 124f extending from the tongue-like plate 124e toward the diaphragm 121 and connected to the diaphragm 121. In this way, when the current passes through the coil 124b, the tongue-like plate 124e is polarized, so that the tongue-like plate 124e may interact with the magnetic field of the magnetic steel 124d, thus the tongue plate 124e is pushed to generate a corresponding vibration. The vibration of the tongue-like plate 124e may drive the second support 124f disposed on the tongue-like plate 124e to vibrate, and may drive the diaphragm 121 to vibrate and generate sound.

In order to simplify the structure of the moving iron driving unit 124, the tongue-like plate 124e may be integrally formed with the second base 124a. Further, the second support 124f may also be integrally formed with the tongue-like plate 124e.

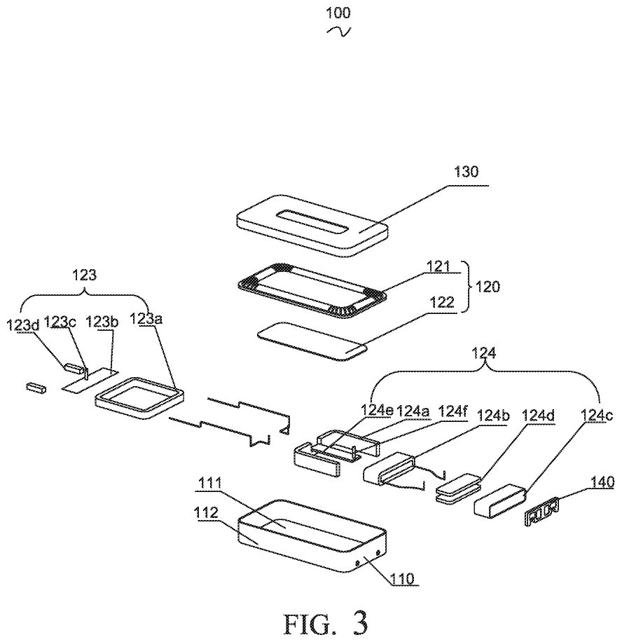

As shown in FIGS. 2 and 3, the housing 110 includes a bottom wall 111 and a side wall 112 formed by bending and extending from the bottom wall 111. In order to improve performance of the vibration to generate sound of the sound generating device 100, a vertical distance between the tongue-like plate 124e and the bottom wall 111 is equal to a vertical distance between the piezoelectric sheet 123b and the bottom wall 111. Further, a length of the first support 123c is equal to a length of the second support 124f. Furthermore, the piezoelectric sheet 123b and the tongue-like plate 124e both have a midline, and the first support 123c and the second support 124f are located at the corresponding midline positions respectively.

The foregoing merely describes embodiments of the present disclosure, and it should be noted that those skilled in the art may further make improvements without departing from the inventive concept of the present disclosure, and all these improvements fall within the protection scope of the present disclosure.

What is claimed is:

1. A sound generating device, comprising a housing, a vibration system accommodated in the housing and a circuit board, the vibration system comprising a diaphragm and a driving unit for driving the diaphragm to vibrate and generate sound, wherein
the driving unit comprises a piezoelectric driving unit and a moving iron driving unit coupled in parallel with the piezoelectric driving unit;
wherein the piezoelectric driving unit comprises a piezoelectric sheet, and the moving iron driving unit comprises a coil and a magnetic steel;
and
the piezoelectric driving unit and the moving iron driving unit jointly drive the diaphragm to vibrate and generate sound.

2. The sound generating device in accordance with claim 1, wherein the piezoelectric driving unit comprises a first base fixed to the housing and fixed to both ends of the piezoelectric sheet, a first support extending from the piezoelectric sheet toward the diaphragm and connected to the diaphragm, and a bump fixing the piezoelectric sheet to the first base.

3. The sound generating device in accordance with claim 2, wherein the first support is integrally formed with the piezoelectric sheet.

4. The sound generating device in accordance with claim 2, wherein the moving iron driving unit comprises a second base fixed to the housing and accommodating the coil, a pole core fixed to the housing and in an annular shape;
the magnetic steel is attached to both sides of the pole core and the magnetic steel extends along a direction that is perpendicular to the vibration direction of the diaphragm; and
the moving iron driving unit further comprises a tongue-like plate extending from the second base through the coil and the pole core, and a second support extending from the tongue-like plate toward the diaphragm and connected to the diaphragm.

5. The sound generating device in accordance with claim 3, wherein the moving iron driving unit comprises a second base fixed to the housing and accommodating the coil, a pole core fixed to the housing and in an annular shape;
the magnetic steel is attached to both sides of the pole core and the magnetic steel extends along a direction that is perpendicular to the vibration direction of the diaphragm; and
the moving iron driving unit further comprises a tongue-like plate extending from the second base through the coil and the pole core, and a second support extending from the tongue-like plate toward the diaphragm and connected to the diaphragm.

6. The sound generating device in accordance with claim 4, wherein the tongue-like plate is integrally formed with the second base.

7. The sound generating device in accordance with claim 5, wherein the tongue-like plate is integrally formed with the second base.

8. The sound generating device in accordance with claim 4, wherein the second support is integrally formed with the tongue-like plate.

9. The sound generating device in accordance with claim 5, wherein the second support is integrally formed with the tongue-like plate.

10. The sound generating device in accordance with claim 4, wherein the housing comprises a bottom wall and a side wall formed by bending and extending from the bottom wall, and a vertical distance between the tongue-like plate and the bottom wall is equal to a vertical distance between the piezoelectric sheet and the bottom wall.

11. The sound generating device in accordance with claim 5, wherein the housing comprises a bottom wall and a side wall formed by bending and extending from the bottom wall, and a vertical distance between the tongue-like plate and the bottom wall is equal to a vertical distance between the piezoelectric sheet and the bottom wall.

12. The sound generating device in accordance with claim 4, wherein a length of the first support is equal to a length of the second support.

13. The sound generating device in accordance with claim 5, wherein a length of the first support is equal to a length of the second support.

14. The sound generating device in accordance with claim 4, wherein the piezoelectric sheet and the tongue-like plate each have a midline, and the first support and the second support are located at the corresponding midline positions respectively.

15. The sound generating device in accordance with claim 5, wherein the piezoelectric sheet and the tongue-like plate each have a midline, and the first support and the second support are located at the corresponding midline positions respectively.

16. The sound generating device in accordance with claim 4, wherein the diaphragm comprises a dome and a suspension formed by bending and extending outward from the dome, and the first support and the second support are both abutted against the dome.

17. The sound generating device in accordance with claim 5, wherein the diaphragm comprises a dome and a suspension formed by bending and extending outward from the dome, and the first support and the second support are both abutted against the dome.
